(19) United States
(12) Patent Application Publication
(10) Pub. No.: US 2021/0062790 A1
(43) Pub. Date: Mar. 4, 2021

(54) Load-Free Wind Power Generating Device

(71) Applicant: Yu-Kun Hsieh, Tainan City (TW)

(72) Inventor: Yu-Kun Hsieh, Tainan City (TW)

(21) Appl. No.: 16/553,856

(22) Filed: Aug. 28, 2019

(51) Int. Cl. F03D 13/10; H02K 7/18; H02K 15/02; F03D 13/20

(52) U.S. Cl. CPC F03D 13/10; F03D 13/20; H02K 15/028; H02K 7/183

(57) ABSTRACT

A wind power generating device includes a stand, a shaft mounted on the stand, a rotor rotatably mounted on the shaft, a stator mounted on the stand and disposed in the rotor, and an impeller mounted on the rotor. The stator includes a plurality of magnetic coil columns and has a central position provided with a hole. The rotor surrounds and covers the stator. The rotor has a central position provided with a bearing mounted on the shaft and has an inner periphery provided with a plurality of magnetic elements corresponding to the magnetic coil columns of the stator. The shaft extends through the hole of the stator and the bearing of the rotor. The bearing of the rotor is locked onto the shaft.

### BACKGROUND OF THE INVENTION

### 1. Field of the Invention

The present invention relates to a generator and, more particularly, to a wind power generating device.

### 2. Description of the Related Art

A wind power generating device, such as a windmill, a wind turbine or the like, is driven by the wind power so as to produce an electric power. Thus, the wind power generating device uses the green energy to achieve an environmental protection purpose. However, the conventional wind power generating device has a complicated structure, thereby increasing the cost of fabrication and installation. In addition, the conventional wind power generating device has a larger volume and is not operated conveniently.

### BRIEF SUMMARY OF THE INVENTION

The primary objective of the present invention is to provide a load-free wind power generating device that is operated without needing any external load.

In accordance with the present invention, there is provided a wind power generating device comprising a stand, a shaft mounted on the stand, a rotor rotatably mounted on the shaft, a stator mounted on the stand and disposed in the rotor, and an impeller mounted on the rotor. The stator includes a plurality of magnetic coil columns. The stator has a central position provided with a hole. The rotor surrounds and covers the stator. The rotor has a central position provided with a bearing mounted on the shaft. The rotor has an inner periphery provided with a plurality of magnetic elements corresponding to the magnetic coil columns of the stator. The shaft extends through the hole of the stator and the bearing of the rotor. The bearing of the rotor is locked onto the shaft. The impeller is secured to the rotor.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a wind power generating device in accordance with the first preferred embodiment of the present invention.

FIG. 2 is a planar view of the rotor of the wind power generating device as shown in FIG. 1.

FIG. 3 is a planar assembly view of the rotor and the stator of the wind power generating device as shown in FIG. 1.

FIG. 4 is a perspective assembly view of the wind power generating device as shown in FIG. 1.

FIG. 5 is a perspective operational view of the wind power generating device as shown in FIG. 4.

FIG. 6 is an exploded perspective view of a wind power generating device in accordance with the second preferred embodiment of the present invention.

FIG. 7 is a perspective view of a wind power generating device in accordance with the third preferred embodiment of the present invention.

FIG. 8 is a planar view of the rotor impeller of a wind power generating device in accordance with the fourth preferred embodiment of the present invention.

FIG. 9 is a planar assembly view of the rotor impeller and the stator of the wind power generating device in accordance with the fourth preferred embodiment of the present invention.

FIG. 10 is an exploded perspective view of the wind power generating device in accordance with the fourth preferred embodiment of the present invention.

FIG. 11 is an exploded perspective view of a wind power generating device in accordance with the fifth preferred embodiment of the present invention.

FIG. 12 is a perspective assembly view of the wind power generating device as shown in FIG. 11.

### DETAILED DESCRIPTION OF THE INVENTION

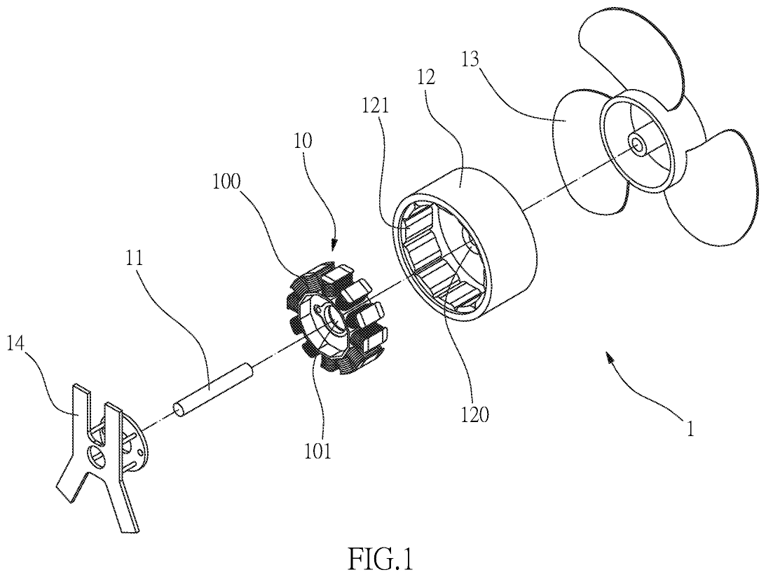

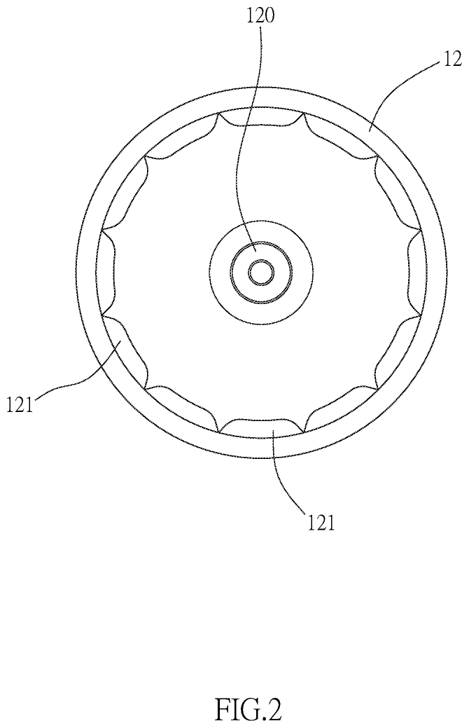

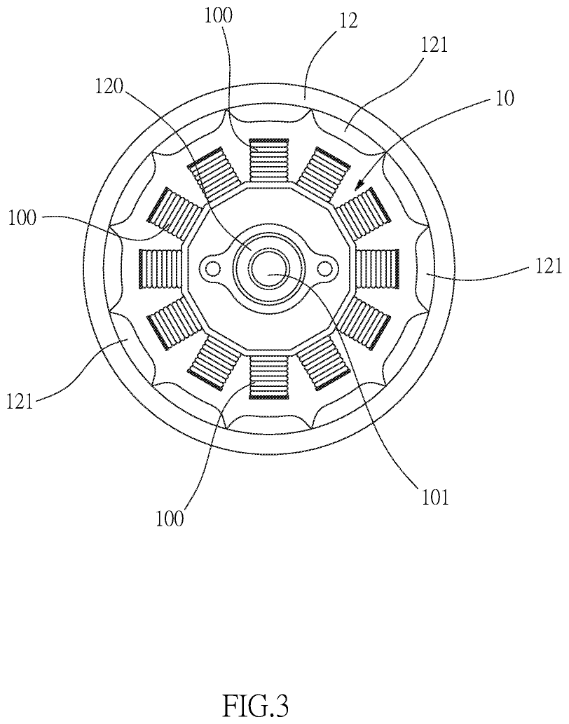

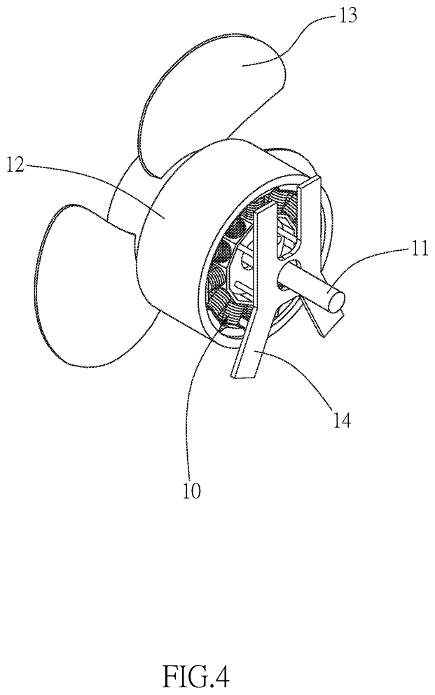

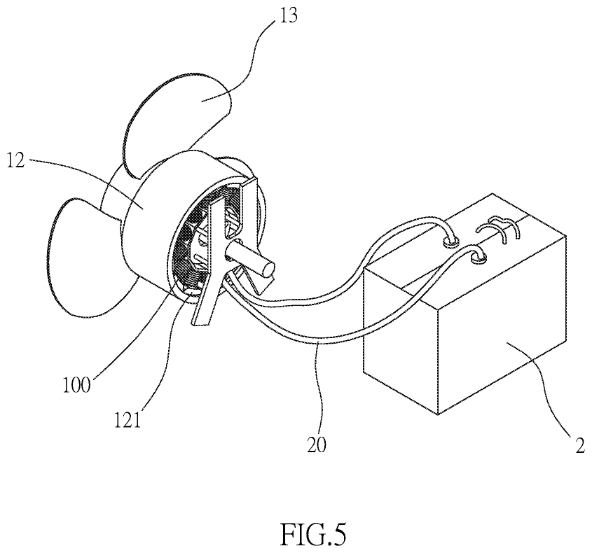

Referring to the drawings and initially to FIGS. 1-5, a wind power generating device 1 in accordance with the preferred embodiment of the present invention comprises a stand 14, a shaft 11 mounted on the stand 14, a rotor (or rotary disk) 12 rotatably mounted on the shaft 11, a stator (or magnetic coil module) 10 mounted on the stand 14 and disposed in the rotor 12, and an impeller (or fan blade) 13 mounted on the rotor 12.

The stator 10 includes a plurality of magnetic coil columns 100. Each of the magnetic coil columns 100 includes a plurality of magnetic coils. The stator 10 has a central position provided with a hole 101, and the shaft 11 passes through the hole 101 of the stator 10. In practice, the stator 10 is electrically connected with a storage battery 2 by electric wires 20. The rotor 12 surrounds and covers the stator 10 and is rotatable relative to the stator 10.

The rotor 12 has a central position provided with a bearing 120 mounted on the shaft 11. The rotor 12 has an inner periphery provided with a plurality of magnetic elements 121 corresponding to the magnetic coil columns 100 of the stator 10. Each of the magnetic elements 121 is a magnet. The shaft 11 extends through the hole 101 of the stator 10 and the bearing 120 of the rotor 12. The bearing 120 of the rotor 12 is locked onto the shaft 11. The impeller 13 is secured to the rotor 12 by screwing. The impeller 13 is mounted on one end of the shaft 11. Preferably, the impeller 13 is a helical fan.

In the preferred embodiment of the present invention, a distance between the magnetic coil columns 100 of the stator 10 and the magnetic elements 121 of the rotor 12 is at least 2 mm.

In operation, when the impeller 13 is driven and rotated by the wind power, the rotor 12 is driven by the impeller 13 and rotated relative to the stator 10, such that the magnetic elements 121 of the rotor 12 are displaced relative to the magnetic coil columns 100 of the stator 10, to produce a magnetic field which is converted by a magnetic conversion to produce an electric current which flows through the electric wires 20 into the storage battery 2. Thus, an electric power is generated through magnetic interaction between the magnetic elements 121 of the rotor 12 and the magnetic coil columns 100 of the stator 10, and is stored in the storage battery 2.

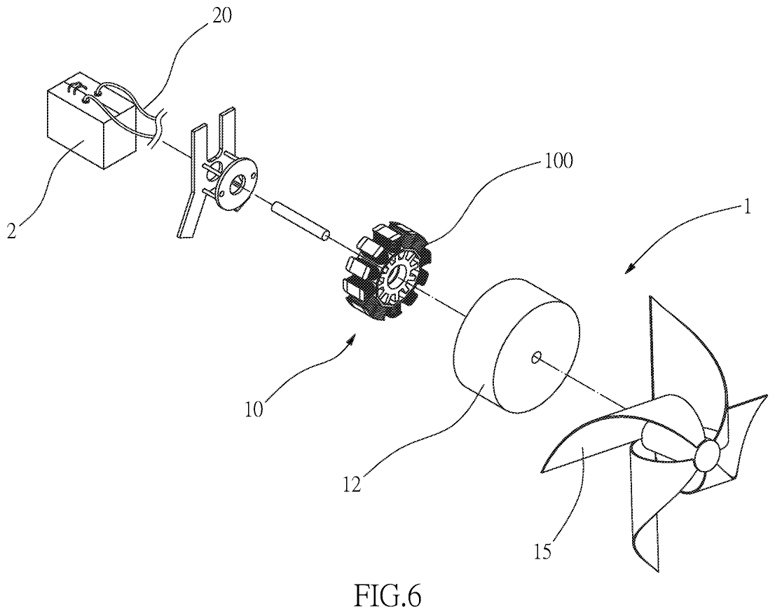

Referring to FIG. 6 with reference to FIGS. 1-5, the impeller is a windmill fan 15. In practice, when the wind power generating device 1 is arranged at a lower position, the windmill fan 15 is used and can be driven easily by a smaller wind power. Thus, when the windmill fan 15 is driven and rotated by the wind power, the rotor 12 is driven by the windmill fan 15 and rotated relative to the stator 10.

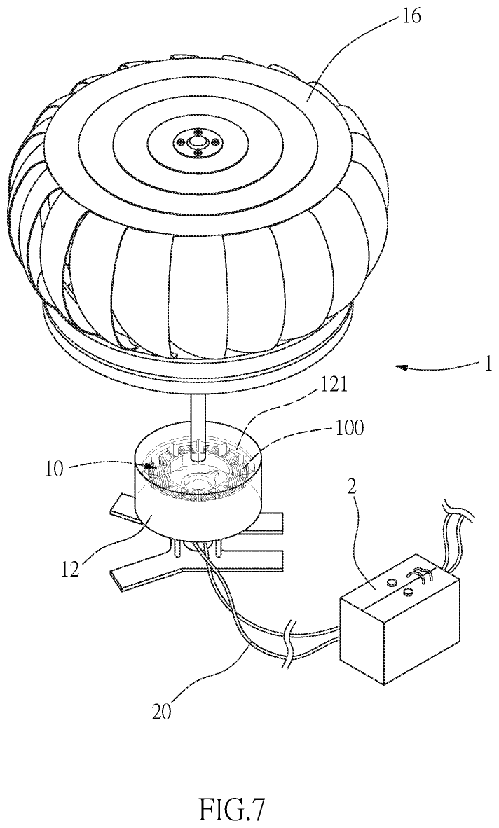

Referring to FIG. 7 with reference to FIGS. 1-5, the impeller is a convection fan (or roof ventilation fan or turbine) 16. In practice, when the wind power generating device 1 is arranged at a higher position, the convection fan 16 is used and can be driven by a wind power that is produced by heat convection. Thus, when the convection fan 16 is driven and rotated by the wind power, the rotor 12 is driven by the convection fan 16 and rotated relative to the stator 10.

Accordingly, the wind power generating device converts the wind energy into an electric energy by a magnetic effect, without using any load, thereby decreasing the cost of production. In addition, the wind power generating device uses the green energy to generate the electric power, thereby preventing from causing an environment pollution. Further, the wind power generating device is operated constantly to generate the electric power all day long, without being limited the weather conditions, thereby enhancing the utility of the wind power generating device. Further, the distance between the magnetic coil columns 100 of the stator 10 and the magnetic elements 121 of the rotor 12 is equal to or more than 2 mm, to increase the rotation speed of the rotor 12, so as to derive the maximum electric power. Further, the impeller 13 is rotated at a smaller speed to rotate the rotor 12, such that the wind power generating device is still operated under a smaller wind power, to produce and supply steady and enough electric energy.

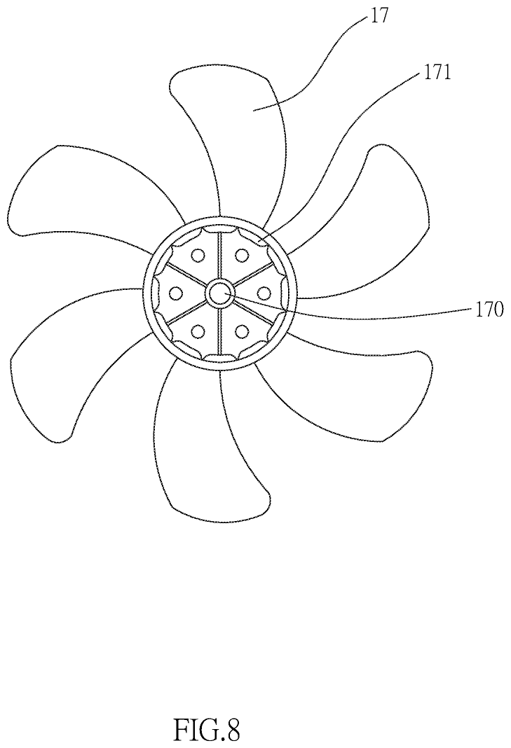

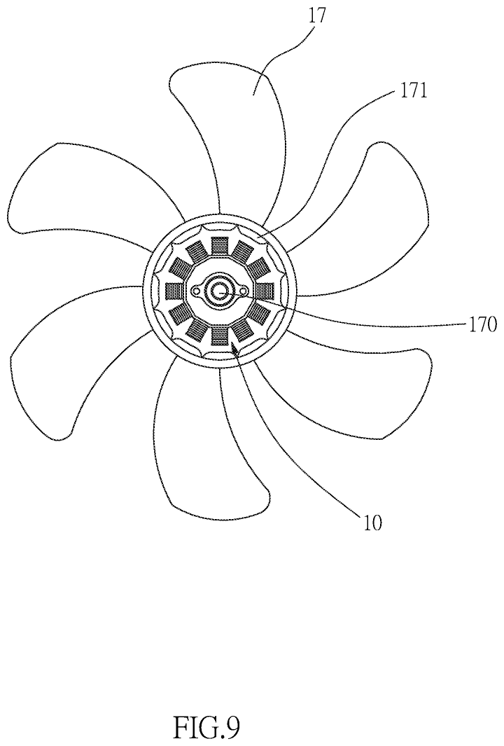

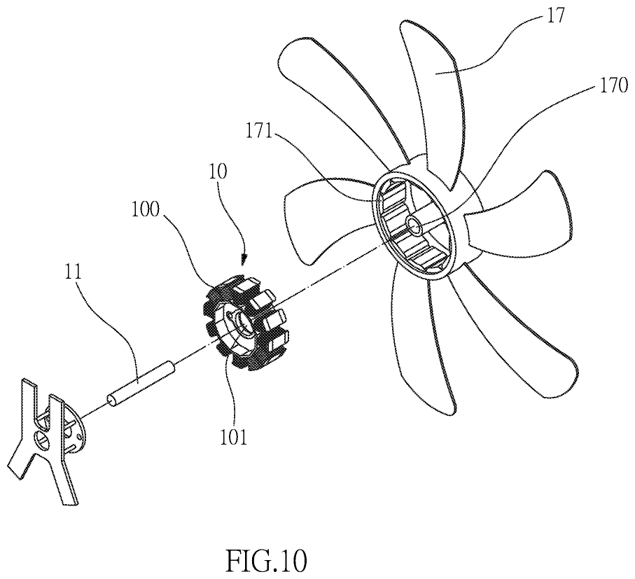

Referring to FIGS. 8-10 with reference to FIGS. 1-5, the impeller 13 and the rotor 12 are integrated to construct a rotor impeller 17. The rotor impeller 17 is rotatably mounted on the shaft 11. The rotor impeller 17 surrounds and covers the stator 10 and is rotatable relative to the stator 10. The rotor impeller 17 has a central position provided with a bearing 170 mounted on the shaft 11. The rotor impeller 17 has an inner periphery provided with a plurality of magnetic elements 171 corresponding to the magnetic coil columns 100 of the stator 10. Each of the magnetic elements 171 is a magnet. The shaft 11 extends through the hole 101 of the stator 10 and the bearing 170 of the rotor impeller 17. The bearing 170 of the rotor impeller 17 is locked onto the shaft 11.

In operation, when the rotor impeller 17 is driven by the wind power, the rotor impeller 17 is rotated relative to the stator 10, such that the magnetic elements 171 of the rotor impeller 17 are displaced relative to the magnetic coil columns 100 of the stator 10, to produce a magnetic field which is converted by a magnetic conversion to produce an electric current.

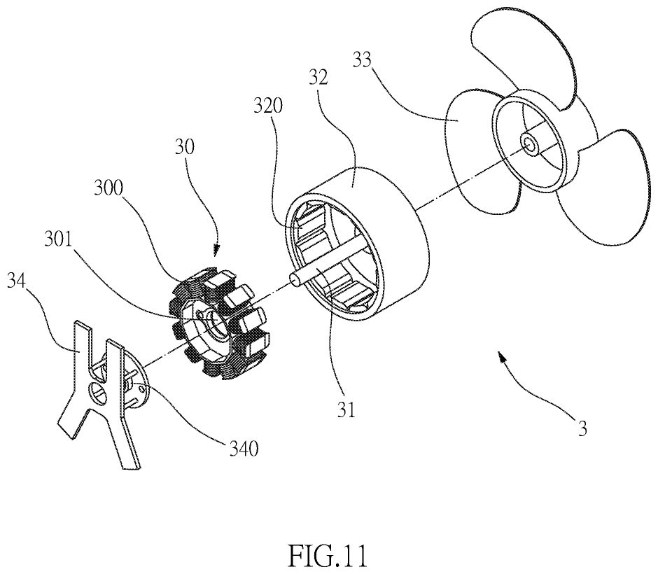

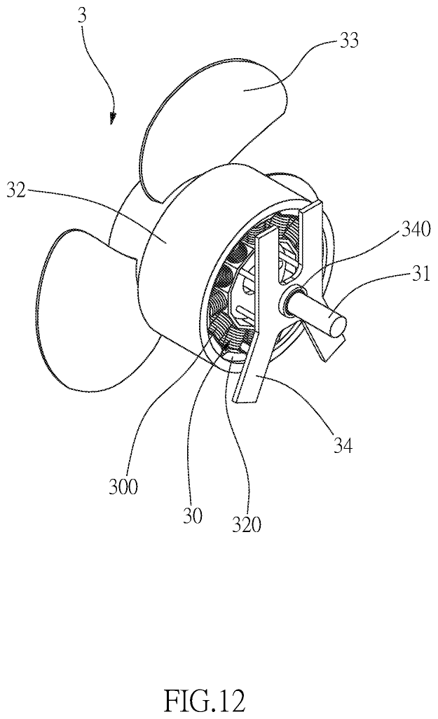

Referring to FIGS. 11 and 12, a wind power generating device 3 in accordance with another preferred embodiment of the present invention comprises a stand 34, a bearing 340 mounted on the stand 34, a stator (or magnetic coil module) 30 mounted on the stand 34, a shaft 31 extending through the stator 30 and the bearing 340, a rotor (or rotary disk) 32 mounted on the shaft 31, and an impeller (or fan blade) 33 mounted on the rotor 32. The stator 30 includes a plurality of magnetic coil columns 300. Each of the magnetic coil columns 300 includes a plurality of magnetic coils. The stator 30 is disposed in the rotor 32 and has a central position provided with a hole 301 allowing passage of the shaft 31. The shaft 31 extends through the hole 301 of the stator 30 and has a first end secured to the bearing 340 and a second end secured to the rotor 32, such that the shaft 31 is rotated in concert with the rotor 32 when the rotor 32 is rotated. The rotor 32 surrounds and covers the stator 30 and is rotatable relative to the stator 30. The rotor 32 has an inner periphery provided with a plurality of magnetic elements 320 corresponding to the magnetic coil columns 300 of the stator 30. Each of the magnetic elements 320 is a magnet. The impeller 33 is secured to the rotor 32. The impeller 33 is mounted on the second end of the shaft 31.

In operation, when the impeller 33 is driven and rotated by the wind power, the rotor 32 is driven by the impeller 33 and rotated relative to the stator 30, such that the magnetic elements 320 of the rotor 32 are displaced relative to the magnetic coil columns 300 of the stator 30, to produce a magnetic field which is converted by a magnetic conversion to produce an electric current. When the rotor 32 is rotated, the shaft 31 is rotated in the bearing 340.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A wind power generating device comprising:
a stand;
a shaft mounted on the stand;
a rotor rotatably mounted on the shaft;
a stator mounted on the stand and disposed in the rotor; and
an impeller mounted on the rotor;
wherein:
the stator includes a plurality of magnetic coil columns;
the stator has a central position provided with a hole;
the rotor surrounds and covers the stator;
the rotor has a central position provided with a bearing mounted on the shaft;
the rotor has an inner periphery provided with a plurality of magnetic elements corresponding to the magnetic coil columns of the stator;
the shaft extends through the hole of the stator and the bearing of the rotor;
the bearing of the rotor is locked onto the shaft; and
the impeller is secured to the rotor.

2. The wind power generating device of claim 1, wherein a distance between the magnetic coil columns of the stator and the magnetic elements of the rotor is at least 2 mm.

3. The wind power generating device of claim 1, wherein the impeller is a helical fan, a windmill fan or a convection fan.

4. The wind power generating device of claim 1, wherein:
the impeller and the rotor are integrated to construct a rotor impeller;
the rotor impeller has a central position provided with a bearing mounted on the shaft; and
the rotor impeller has an inner periphery provided with a plurality of magnetic elements corresponding to the magnetic coil columns of the stator.

5. A wind power generating device comprising:
a stand;
a bearing mounted on the stand;
a stator mounted on the stand;
a shaft extending through the stator and the bearing;
a rotor mounted on the shaft; and
an impeller mounted on the rotor;
wherein:
the stator includes a plurality of magnetic coil columns;
the stator has a central position provided with a hole;
the shaft extends through the hole of the stator and has a first end secured to the bearing and a second end secured to the rotor;
the rotor surrounds and covers the stator;
the rotor has an inner periphery provided with a plurality of magnetic elements corresponding to the magnetic coil columns of the stator; and
the impeller is secured to the rotor.
